(19) United States
(12) Patent Application Publication
(10) Pub. No.: US 2016/0186687 A1
(43) Pub. Date: Jun. 30, 2016

(54) PISTON OF INTERNAL COMBUSTION ENGINE AND INTERNAL COMBUSTION ENGINE PROVIDED THEREWITH

(71) Applicant: Toyota Jidosha Kabushiki Kaisha, Toyota-shi, Aichi-ken (JP)

(72) Inventor: Takeshi MINOOKA, Toyota-shi (JP)

(73) Assignee: TOYOTA JIDOSHA KABUSHIKI KAISHA, Toyota-shi, Aichi-ken (JP)

(21) Appl. No.: 14/653,692

(22) PCT Filed: Dec. 19, 2013
(86) PCT No.: PCT/IB2013/003040

§ 371 Date: Jun. 18, 2015

(30) Foreign Application Priority Data
Dec. 21, 2012 (JP) 2012-279400

(51) Int. Cl. F02F 3/24

(52) U.S. Cl. CPC F02F 3/24

(57) ABSTRACT

A piston of an internal combustion engine, includes an intake-side recess and an exhaust-side recess. At a peripheral edge of at least one recess, of the intake-side recess and the exhaust-side recess, a curvature radius of a cross-section along the defined direction of a portion where the recess is connected to a portion of the piston top surface that is on one side of the recess in the defined direction, is smaller than a curvature radius of a cross-section along the defined direction of a portion where the recess is connected to a portion of the piston top surface that is on the other side of the recess in the defined direction.

### BACKGROUND OF THE INVENTION

1. Field of the Invention

The invention relates to a piston of an internal combustion engine that generates tumble flow in a combustion chamber, and an internal combustion engine provided with this piston.

2. Description of Related Art

When a tumble flow is generated in a combustion chamber by intake air flowing into the combustion chamber from an intake port, turbulence is generated in a flow of intake air. As a result, the rate of combustion of the air-fuel mixture increases, so an air-fuel mixture is stably combusted (see Japanese Patent Application Publication No. 2010-53710 (JP 2010-53710 A), for example).

### SUMMARY OF THE INVENTION

A piston in which a recess to avoid contact with an intake valve or an exhaust valve is formed in the top surface of the piston is known. In an internal combustion engine employing this type of piston, when an air-fuel mixture flows along a top surface of the piston due to the generation of tumble flow within the combustion chamber, the flow of the air-fuel mixture into and out of this recess may lead to attenuation of the tumble flow.

The invention thus provides a piston of an internal combustion engine, which inhibits attenuation of the tumble-flow generated inside the combustion chamber, and an internal combustion engine provided with this piston.

One aspect of the invention relates to a piston of an internal combustion engine. This piston includes an intake-side recess for an intake valve, the intake-side recess being formed in a piston top surface, and an exhaust-side recess for an exhaust valve, the exhaust-side recess being formed in the piston top surface. When a direction in which the intake-side recess and the exhaust-side recess are lined up is a defined direction, the piston generates, in a combustion chamber, a tumble flow that creates a flow of intake air that flows from one side in the defined direction toward the other side in the defined direction over the piston top surface. Also, at a peripheral edge of at least one recess, of the intake-side recess and the exhaust-side recess, a curvature radius of a cross-section along the defined direction of a portion where the recess is connected to a portion of the piston top surface that is on one side of the recess in the defined direction, is smaller than a curvature radius of a cross-section along the defined direction of a portion where the recess is connected to a portion of the piston top surface that is on the other side of the recess in the defined direction.

The piston in the aspect described above may be applied to an internal combustion engine that generates a tumble flow inside a combustion chamber. In this case, the air-fuel mixture that has flowed from the one side in the defined direction to near the recess will not easily flow into the recess, because the curvature radius of one side portion (i.e., a portion on one side) of the peripheral edge of the recess is smaller than the curvature radius of the other side portion (i.e., a portion on the other side). Also, when the air-fuel mixture reaches the other side portion of the peripheral edge of the recess without flowing into the recess, the flow of the air-fuel mixture is able to be smoothly adjusted to a flow along the shape of the piston top surface by the other side portion, because the curvature radius of the other side portion is larger than the curvature radius of the one side portion. That is, the air-fuel mixture flows from one direction toward the other direction, in the defined direction, along the piston top surface while being inhibited from flowing into the recess, so attenuation of the tumble flow generated in the combustion chamber is able to be inhibited.

A recess having a structure in which the curvature radius of the one side portion of the peripheral edge is smaller than the curvature radius of the other side portion may be employed for only one of the intake-side recess and the exhaust-side recess that are lined up in the defined direction, but in order to increase the tumble flow attenuation inhibiting effect, a recess having the structure described above may be employed for both the intake-side recess and the exhaust-side recess.

Also, a curvature radius of the one side portion of the peripheral edge of one recess, of the intake-side recess and the exhaust-side recess, may be smaller than a curvature radius of the other side portion of the peripheral edge of the other recess. As a result, when the air-fuel mixture passes over the one recess in the defined direction, the air-fuel mixture will not easily flow into the one recess. Thus, attenuation of the tumble flow generated in the combustion chamber is able to be inhibited.

Further, the curvature radius of the other side portion of the peripheral edge of one recess, of the intake-side recess and the exhaust-side recess, may be larger than the curvature radius of the one side portion of the peripheral edge of the other recess. As a result, when the air-fuel mixture passes over the other recess in the defined direction, the air-fuel mixture will not easily flow into the other recess. Thus, attenuation of the tumble flow generated in the combustion chamber is able to be inhibited.

Also, an internal combustion engine which, when a direction in which an intake-side recess for an intake valve, which is formed in a piston top surface, and an exhaust-side recess for an exhaust valve, which is formed in the piston top surface, are lined up is a defined direction, generates, in a combustion chamber, a tumble flow that creates a flow of intake air that flows from one side in the defined direction toward the other side in the defined direction over the piston top surface, is presupposed. A piston provided in such an internal combustion engine may be the piston of the aspect described above. With this structure, operation and effects similar to those obtained by the piston of an internal combustion engine described above are able to be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view showing a frame format of one example embodiment of the invention;

FIG. 2 is a plan view showing a frame format of a top surface of a piston;

FIG. 3A is an arrow sectional view taken along line 3-3 in FIG. 2;

FIG. 3B is an enlarged view of a portion in FIG. 3A;

FIG. 3C is an enlarged view of another portion in FIG. 3A;

FIG. 3D is an enlarged view of yet another portion in FIG. 3A;

FIG. 3E is an enlarged view of still another portion in FIG. 3A;

FIG. 4A is a sectional view of a portion of a piston according to a comparative example;

FIG. 4B is an enlarged view of a portion in FIG. 4A;

FIG. 4C is an enlarged view of another portion in FIG. 4A;

FIG. 4D is an enlarged view of yet another portion in FIG. 4A;

FIG. 4E is an enlarged view of still another portion in FIG. 4A;

FIG. 5 is a graph showing the relationship between rotation angle of a crankshaft and tumble ratio; and

FIG. 6 is a graph showing the relationship between rotation angle of the crankshaft and disturbance in the flow of an air-fuel mixture.

### DETAILED DESCRIPTION OF EMBODIMENTS

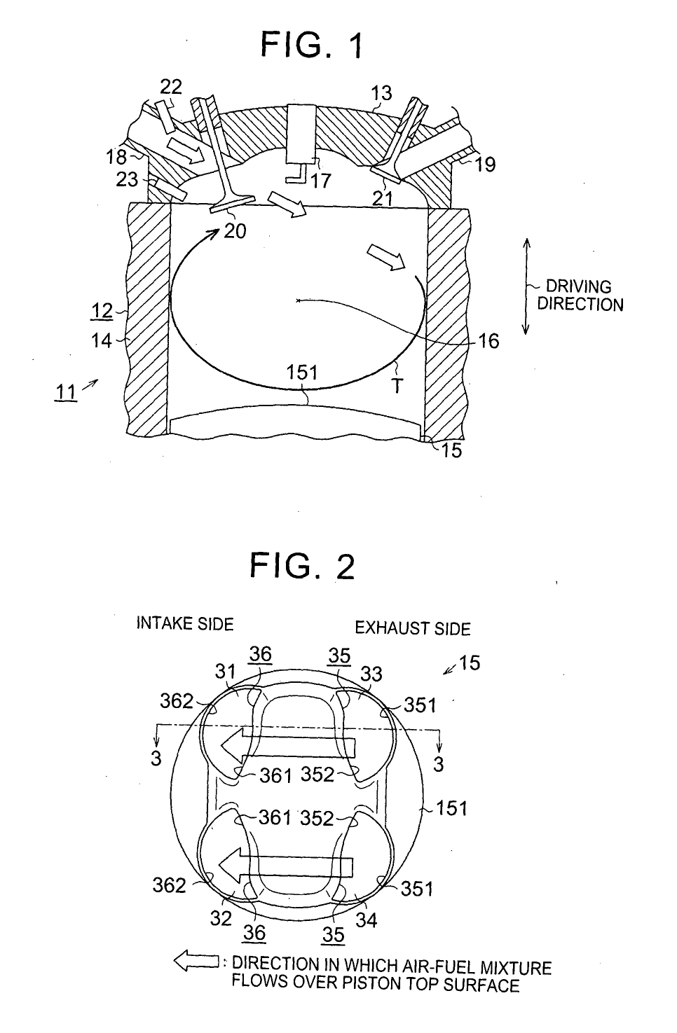

Hereinafter, one example embodiment of an internal combustion engine that generates a tumble flow inside a combustion chamber will be described with reference to FIGS. 1 to 6. As shown in FIG. 1, a cylinder head 13 is assembled to a cylinder block 12 of an internal combustion engine 11, and a piston 15 that moves in a reciprocating manner toward and away from the cylinder head 13 is provided inside a cylinder 14 of this cylinder block 12. Also, a combustion chamber 16 is formed between the cylinder head 13 and the piston 15 inside the cylinder 14.

In this example embodiment, the direction in which the piston 15 moves in a reciprocating manner inside the cylinder 14 will be referred to as “driving direction”. Also, a side in the direction in which the volume of the combustion chamber 16 becomes smaller, i.e., an upper side in FIG. 1, will be referred to as “one side in the driving direction”, and a side in the direction in which the volume of the combustion chamber 16 becomes larger, i.e., a lower side in FIG. 1, will be referred to as “the other side in the driving direction”.

A spark plug 17 is attached to the cylinder head 13 in a position facing the center of the cylinder 14. Also, an plurality of intake ports 18 (two in this example embodiment) are provided on the left side of the spark plug 17 in FIG. 1, and the same number of exhaust ports 19 as there are intake ports 18 (i.e., two in this example embodiment) are provided on the right side of the spark plug 17 in FIG. 1. Hereinafter, whenever possible the intake ports 18 and the exhaust ports 19, as well as other portions that are provided in plurality, will be referred to in the singular to simplify the description.

The intake ports 18 are arranged lined up in a direction orthogonal to the paper on which FIG. 1 is drawn. When an intake valve 20 opens, gas that includes at least intake air is drawn into the combustion chamber 16 through the intake port 18. The intake port 18 in this example embodiment is formed such that a large portion of the gas that is drawn into the combustion chamber 16 through the intake port 18 flows toward an exhaust-side region that is farthest from the intake port 18 on an inner peripheral surface of the cylinder 14. As a result, during an intake stroke, a tumble flow T is created by the gas flowing into the combustion chamber 16 through the intake port 18.

The tumble flow T in this example embodiment is a rotating flow of gas that includes a flow of gas from the intake port 18 directly toward an area near the spark plug 17, and indicates a rotating flow of gas that flows in a clockwise direction in FIG. 1. In this example embodiment, two of the intake ports 18 are provided, so two tumble flows T are created in a direction orthogonal to the paper on which FIG. 1 is drawn.

Similar to the intake ports 18, the exhaust ports 19 are also arranged lined up in a direction orthogonal to the paper on which FIG. 1 is drawn. When an exhaust valve 21 opens during an exhaust stroke, exhaust gas is discharged from the combustion chamber 16 through the exhaust port 19.

In this example embodiment, two types of injection valves 22 and 23 are provided for each cylinder 14. One injection valve, of the injection valves 22 and 23, is a passage injection valve 22 for injecting fuel into the intake port 18. The other injection valve is an in-cylinder injection valve 23 for injecting fuel into the cylinder 14. An air-fuel mixture that includes fuel injected from at least one injection valve, from among these injection valves 22 and 23, is combusted by the spark plug 17, and the force resulting from this combustion causes the piston 15 to move in a reciprocating manner.

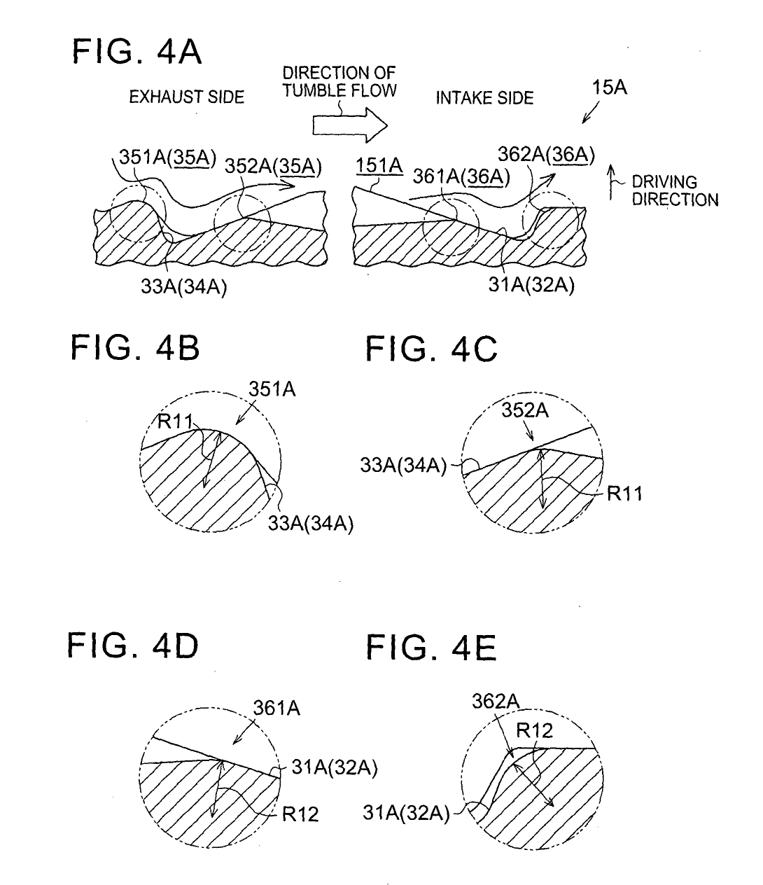

Next, the shape of a piston top surface 151 will be described with reference to FIGS. 2 to 4. FIG. 4 shows the sectional shape of a portion of a piston 15A according to a comparative example. As shown in FIG. 2, intake-side recesses 31 and 32 for avoiding contact with the intake valves 20, and exhaust-side recesses 33 and 34 for avoiding contact with the exhaust valves 21, are formed in the piston top surface 151. In this example embodiment, the direction in which the exhaust-side recess 33 positioned on the upper side in FIG. 2, from among the exhaust-side recesses 33 and 34, is lined up with the intake-side recess 31 positioned on the upper side in FIG. 2, from among the exhaust-side recesses 31 and 32, as well as the direction in which the exhaust-side recess 34 positioned on the lower side in FIG. 2 is lined up with the intake-side recess 32 positioned on the lower side in FIG. 2, will both be referred to as the “defined direction”.

When the tumble flow T is generated in the combustion chamber 16, the gas that flows in the clockwise direction in FIG. 1 flows over the piston top surface 151 from the exhaust side toward the intake side. At this time, the gas passes over the exhaust-side recesses 33 and 34 from the exhaust side (i.e., the right side in FIG. 2; one side in the defined direction) toward the intake side (i.e., the left side in FIG. 2; the other side in the defined direction). Then the gas that has passed over the exhaust-side recesses 33 and 34 passes over the intake-side recesses 31 and 32 from the exhaust side toward the intake side.

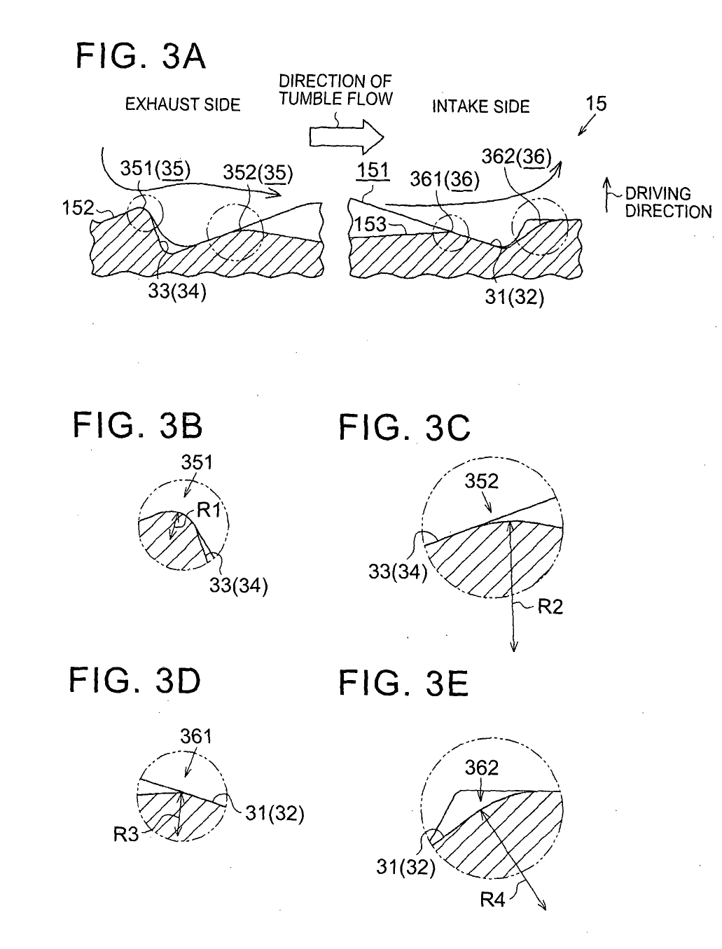

FIGS. 3A to 3E are sectional views of portions when the piston 15 is cut along the defined direction. As shown in FIGS. 3A and 3B, a portion 152 on the exhaust side (i.e., the left side in FIG. 3A; one side in the defined direction) of the exhaust-side recesses 33 and 34 in the piston top surface 151 has an inclined shape that extends farther toward the one side in the driving direction, closer to the exhaust-side recesses 33 and 34. Also, a curvature radius of an exhaust-side portion 351 that serves as a portion on one side (hereinafter, simply referred to as “one side portion”), in the defined direction, of a peripheral edge 35 of the exhaust-side recesses 33 and 34 is a first curvature radius R1. Also, as shown in FIG. 3C, a curvature radius of an intake-side portion 352 that serves as a portion on the other side (hereinafter, simply referred to as “the other side portion”), in the defined direction, of the peripheral edge 35 of the exhaust-side recesses 33 and 34 is a second curvature radius R2 that is larger than the curvature radius (R 1) of the exhaust-side portion 351.

Also, as shown in FIGS. 3A and 3D, an exhaust side-portion 153 of the intake-side recesses 31 and 32 of the piston top surface 151 has an inclined shape that extends farther toward the one side in the driving direction, closer to the intake-side recesses 31 and 32. Also, a curvature radius of an exhaust-side portion 361 that serves as a portion on one side (hereinafter, simply referred to as “one side portion”), in the defining direction, of a peripheral edge 36 of the intake-side recesses 31 and 32 is a third curvature radius R3. Also, this third curvature radius is smaller than the second curvature radius R2.

Also, as is shown in FIG. 3E, a curvature radius of an intake-side portion 362 that serves as a portion on the other side (hereinafter, simply referred to as “the other side portion”), in the defined direction, of the peripheral edge 36 of the intake-side recesses 31 and 32 is a fourth curvature radius R4 that is larger than the curvature radius (R3) of the exhaust-side portion 361. Also, this fourth curvature radius R4 is larger than the first curvature radius R1.

Here, the shape of a piston top surface 151A according to related art will be described as a comparative example, with reference to FIG. 4. As shown in FIGS. 4A to 4E, an exhaust-side portion 351A of a peripheral edge 35A of exhaust-side recesses 33A and 34A in the piston top surface 151A of the comparative example has an eleventh curvature radius R11, just as does an intake-side portion 352A. This eleventh curvature radius R11 is larger than the first curvature radius R1 and smaller than the second curvature radius R2. In other words, the curvature radius (R1) of the exhaust-side portion 351 of the peripheral edge 35 of the exhaust-side recesses 33 and 34 of this example embodiment is smaller than the curvature radius (R11) of the exhaust-side portion 351 A of the peripheral edge 35A of the exhaust-side recesses 33A and 34A of the comparative example. Also, the curvature radius (R2) of the intake-side portion 352 of the peripheral edge 35 of the exhaust-side recesses 33 and 34 of this example embodiment is larger than the curvature radius (R11) of the intake-side portion 352A of the peripheral edge 35A of the exhaust-side recesses 33A and 34A of the comparative example.

Also, an exhaust-side portion 361 A of a peripheral edge 36A of intake-side recesses 31A and 32A has a twelfth curvature radius R12, just as does an intake-side portion 362A. This twelfth curvature radius R12 is larger than the third curvature radius R3 and smaller than the fourth curvature radius R4. In other words, the curvature radius (R3) of the exhaust-side portion 361 of the peripheral edge 36 of the inside-side recesses 31 and 32 of this example embodiment is smaller than the curvature radius (R12) of the exhaust-side portion 361 A of the peripheral edge 36A of the intake-side recesses 31A and 32A of the comparative example. Also, the curvature radius (R4) of the intake-side portion 362 of the peripheral edge 36 of the intake-side recesses 31 and 32 of this example embodiment is larger than the curvature radius (R12) of the intake-side portion 362A of the peripheral edge 36A of the intake-side recesses 31A and 32A of the comparative example.

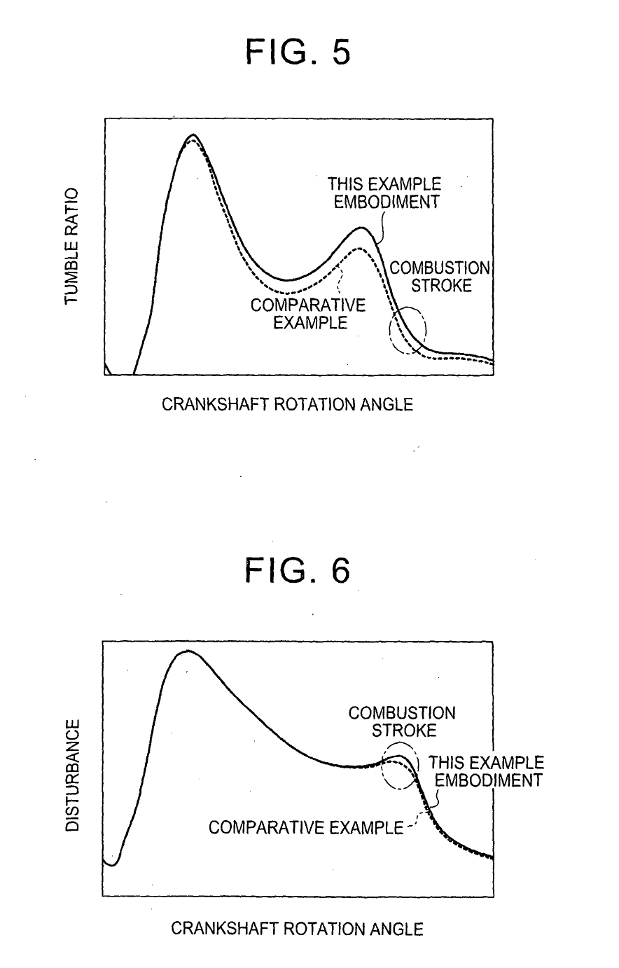

Next, the operation of the internal combustion engine 11 of this example embodiment will be described with reference to the graphs in FIGS. 5 and 6. When gas is drawn into the combustion chamber 16 through the intake port 18, the tumble flow T is created inside the combustion chamber 16. When this happens, the air-fuel mixture that includes intake air and fuel flows over the piston top surface 151 from the exhaust side to the intake side. When the air-fuel mixture flows over the piston top surface 151 in this way, the air-fuel mixture passes over the exhaust-side recesses 33 and 34.

At this time, when the curvature radius of the peripheral edge 35A is the curvature radius R11 as in the comparative example described above, the curvature radius of the exhaust-side portion 351A is large, so the air-fuel mixture is easily guided into the exhaust-side recesses 33A and 34A. Therefore, most of the air-fuel mixture flows into the exhaust-side recesses 33A and 34A from the exhaust-side portion 351A, and then the air-fuel mixture flows out of the exhaust-side recesses 33A and 34A via the intake-side portion 352A.

The air-fuel mixture that flows out of the exhaust-side recesses 33A and 34A flows to the intake side along the piston top surface 151A and reaches a position right before the intake-side recesses 31A and 32A. Even at this time, when the curvature radius of the peripheral edge 36A is the curvature radius R12, as it is in the comparative example described above, the curvature radius of the exhaust-side portion 361A is large, so air-fuel mixture is easily guided into the intake-side recesses 31A and 32A. Therefore, most of the air-fuel mixture flows into the intake-side recesses 31A and 32A from the exhaust-side portion 361A, and then the air-fuel mixture flows out of the intake-side recesses 31A and 32A via the intake-side portion 362A.

That is, when the air-fuel mixture flows over the piston top surface 151 A from the exhaust side toward the intake side, the flow rate thereof, i.e., the tumble flow T, is attenuated by the air-fuel mixture flowing into and out of the recesses.

In contrast, in the example embodiment, the curvature radius of the exhaust-side portion 351 of the peripheral edge 35 of the exhaust-side recesses 33 and 34 is the first curvature radius RI that is smaller than the eleventh curvature radius R11. Therefore, when the air-fuel mixture passes over the exhaust-side recesses 33 and 34 from the exhaust side to the intake side, the air-fuel mixture is not easily guided into the exhaust-side recesses 33 and 34. Thus, most of the air-fuel mixture passes above the exhaust-side recesses 33 and 34, instead of flowing into the exhaust-side recesses 33 and 34.

Also, when the air-fuel mixture that passes above the exhaust-side recesses 33 and 34 reaches an area near the intake-side portion 352 of the peripheral edge 35 of the exhaust-side recesses 33 and 34, the direction in which the air-fuel mixture flows changes smoothly to a direction along the piston top surface 151 by the intake-side portion 352. This is because the curvature radius of the intake-side portion 352 is the second curvature radius R2 that is larger than both the first curvature radius R1 and the eleventh curvature radius R11.

Then, when the air-fuel mixture that has passed over the exhaust-side recess 33 and 34 flows to the intake side along the piston top surface 151, it reaches a position right before the intake-side recesses 31 and 32. The curvature ,radius of the exhaust-side portion 361 of the peripheral edge 36 of the intake-side recesses 31 and 32 is the third curvature radius R3 that is smaller than the twelfth curvature radius R12. Therefore, when the air-fuel mixture passes over the intake-side recesses 31 and 32 from the exhaust side toward the intake side, the air-fuel mixture will not easily be guided into the intake-side recesses 31 and 32. Thus, most of the air-fuel mixture will pass above the intake-side recesses 31 and 32, instead of flowing into the intake-side recesses 31 and 32.

Also, when the air-fuel mixture that passes above the intake-side recesses 31 and 32 reaches an area near the intake-side portion 362 of the peripheral edge 36 of the intake-side recesses 31 and 32, the direction in which the air-fuel mixture flows changes smoothly to a direction along the piston top surface 151 by the intake-side portion 362. This is because the curvature radius of the intake-side portion 362 is the fourth curvature radius R4 that is larger than both the third curvature radius R3 and the twelfth curvature radius R12.

When attenuation of the flow rate when the air-fuel mixture flows along the piston top surface 151 is inhibited in this way, values indicative of the disturbance in the tumble flow T and the tumble ratio during the combustion stroke are set larger than they are in the comparative example, as shown in FIGS. 5 and 6. As a result, the combustion rate of the air-fuel mixture increases, so the air-fuel mixture is stably combusted.

The tumble ratio here is the number of times that the tumble flow T rotates while the piston 15 moves up and down (back and forth) once. Also, the value indicative of the disturbance is a value indicative of a difference between an average value of the flow rate inside the combustion chamber 16, and the flow rate at a predetermined point inside the combustion chamber 16. The disturbance of the tumble flow T increases as this difference increases.

As described above, with this example embodiment, the effects described below are able to be obtained. The curvature radius of the exhaust-side portions 351 and 361 of the peripheral edges 35 and 36 of the recesses 31 to 34 is made smaller than the curvature radius of the intake-side portions 352 and 362. As a result, when the air-fuel mixture flows over the piston top surface 151 from the exhaust side to the intake side, the air-fuel mixture will not easily flow into the recesses 31 to 34. Also, the direction in which the air-fuel mixture that passes over the recesses 31 to 34 is smoothly adjusted to a direction along the piston top surface 151 by the intake-side portions 352 and 362. As a result, attenuation of the flow rate when the air-fuel mixture flows along the piston top surface 151 is able to be inhibited, so attenuation of the tumble flow T inside the combustion chamber 16 is able to be inhibited. Therefore, the fuel consumption of the internal combustion engine 11 is able to be improved.

The example embodiment may also be modified to another example embodiment such as that described below. As long as the curvature radius of the exhaust-side portion 351 of the peripheral edge 35 of the exhaust-side recesses 33 and 34 is smaller than the curvature radius of the intake-side portion 352, the curvature radius of the exhaust-side portion 361 of the peripheral edge 36 of the intake-side recesses 31 and 32 may be the same as the curvature radius of the intake-side portion 362.

As long as the curvature radius of the exhaust-side portion 361 of the peripheral edge 36 of the intake-side recesses 31 and 32 is smaller than the curvature radius of the intake-side portion 362, the curvature radius of the exhaust-side portion 351 of the peripheral edge 35 of the exhaust-side recesses 33 and 34 may be the same as the curvature radius of the intake-side portion 352.

The internal combustion engine 11 may also generate a tumble flow such that the air-fuel mixture flows over the piston top surface 151 from the intake side toward the exhaust side. In this case, the intake-side portions 352 and 362 of the peripheral edges 35 and 36 of the recesses 31 to 34 correspond to the one side portion in the defined direction, and the exhaust-side portions 351 and 361 correspond to the other side portion in the defined direction. Also, the curvature radius of the intake-side portions 352 and 362 may be smaller than the curvature radius of the exhaust-side portions 351 and 361.

1. A piston of an internal combustion engine, the piston comprising:
an intake-side recess for an intake valve, the intake-side recess being formed in a piston top surface; and
an exhaust-side recess for an exhaust valve, the exhaust-side recess being formed in the piston top surface, wherein
a direction in which the intake-side recess and the exhaust-side recess are lined up is a defined direction, the piston generates, in a combustion chamber, a tumble flow that creates a flow of intake air that flows from one side in the defined direction toward the other side in the defined direction over the piston top surface; and
at a peripheral edge of at least one recess, of the intake-side recess and the exhaust-side recess, a curvature radius of a cross-section along the defined direction of a portion where the recess is connected to a portion of the piston top surface that is on one side of the recess in the defined direction, is smaller than a curvature radius of a cross-section along the defined direction of a portion where the recess is connected to a portion of the piston top surface that is on the other side of the recess in the defined direction.

2. The piston according to claim 1, wherein
at the peripheral edge of both recesses, of the intake-side recess and the exhaust-side recess, the curvature radius of the cross-section along the defined direction of the portion where the recess is connected to the portion of the piston top surface that is on one side of the recess in the defined direction, is smaller than the curvature radius of the cross-section along the defined direction of the portion where the recess is connected to the portion of the piston top surface that is on the other side of the recess in the defined direction.

3. The piston according to claim 1, wherein
the curvature radius, at the peripheral edge of one recess, of the intake-side recess and the exhaust-side recess, of the cross-section along the defined direction of the portion where the recess is connected to the portion of the piston top surface that is on one side of the recess in the defined direction, is smaller than the curvature radius, at the peripheral edge of the other recess, of the intake-side recess and the exhaust-side recess, of the cross-section along the defined direction of the portion where the other recess is connected to the portion of the piston top surface that is on the other side of the other recess in the defined direction.

4. An internal combustion engine comprising:
a piston, including
an intake-side recess for an intake valve, the intake-side recess being formed in a piston top surface; and
an exhaust-side recess for an exhaust valve, the exhaust-side recess being formed in the piston top surface, wherein
a direction in which the intake-side recess and the exhaust-side recess are lined up is a defined direction, the piston generates, in a combustion chamber, a tumble flow that creates a flow of intake air that flows from one side in the defined direction toward the other side in the defined direction over the piston top surface; and
at a peripheral edge of at least one recess, of the intake-side recess and the exhaust-side recess, a curvature radius of a cross-section along the defined direction of a portion where the recess is connected to a portion of the piston top surface that is on one side of the recess in the defined direction, is smaller than a curvature radius of a cross-section along the defined direction of a portion where the recess is connected to a portion of the piston top surface that is on the other side of the recess in the defined direction, wherein
the internal combustion engine generates, in the combustion chamber, a tumble flow that creates a flow of intake air that flows from one side in the defined direction toward the other side in the defined direction over the piston top surface.
